(19) United States
(12) Patent Application Publication
(10) Pub. No.: US 2018/0244012 A1
(43) Pub. Date: Aug. 30, 2018

(54) FLAP FOLDING ASSEMBLY

(71) Applicant: Packaging Progressions, Inc., Souderton, PA (US)

(72) Inventors: Lawrence Ward, Schwenksville, PA (US); Charles D. Faust, Bensalem, PA (US); Chad Ezra Dudonis, Pottstown, PA (US)

(73) Assignee: Packaging Progressions, Inc., Souderton, PA (US)

(21) Appl. No.: 15/878,824

(22) Filed: Jan. 24, 2018

Related U.S. Application Data
(60) Provisional application No. 62/464,806, filed on Feb. 28, 2017.

(51) Int. Cl. B31F 1/00; B65H 9/10; B65H 5/02

(52) U.S. Cl. CPC B31F 1/0019; B65H 9/106; B65H 2301/33224; B65H 2301/45; B65H 5/021

(57) ABSTRACT

A folding arrangement including a flap lifting assembly located at a drop conveyor discharge end and including a pivoting arm with a flap engaging surface that is movable between a first, flap-lifting position and a second, pass-through position is provided. A folding assembly includes a receiving conveyor with a receiving conveyor feed end positioned below the drop conveyor discharge end, and a folding finger above the receiving conveyor feed end. The product-substrate combination is driven by the drop conveyor into contact with the flap engaging surface in the first position to lift the flap as the product-substrate combination is discharged from the drop conveyor discharge end towards the receiving conveyor feed end, and the folding finger contacts the flap of the product-substrate combination to complete folding of the flap to a second angled position onto the product as the product-substrate combination pivots the flap engaging surface to the second position.

### INCORPORATION BY REFERENCE

The following document is incorporated herein by reference as if fully set forth: U.S. Provisional Application No. 62/464,806, filed Feb. 28, 2017.

### FIELD OF THE INVENTION

The invention generally relates to a conveyor arrangement, and more particularly relates to a flap folding assembly for a conveyor arrangement.

### BACKGROUND

It is well known to use conveyors to direct products with respect to an assembly line. Products can be placed on substrates, such as packaging, wrapping, wax paper, or other material. After the products are placed on the substrate to form a product-substrate combination, subsequent folding of a flap of the substrate is typically required for further processing of the product-substrate combination. It is time consuming and expensive to manually fold the flaps of the substrates, and it would be desirable to provide an automated and reliable solution for folding these flaps.

### SUMMARY

A folding arrangement for a product-substrate combination including a flap folding assembly is disclosed. The folding arrangement includes a drop conveyor configured to receive a product-substrate combination at a drop conveyor feed end and to direct the product-substrate combination toward a drop conveyor discharge end. The product-substrate combination includes a product arranged on a substrate and the substrate includes a flap positioned at a first angled position. A flap lifting assembly is located at the drop conveyor discharge end and includes a pivoting arm with a flap engaging surface that is movable between a first, flap-lifting position and a second, pass-through position. A folding assembly includes a receiving conveyor with a receiving conveyor feed end positioned below the drop conveyor discharge end, and a folding finger positioned above the receiving conveyor feed end. The product-substrate combination is driven by the drop conveyor into contact with the flap engaging surface in the first, flap-lifting position to lift the flap as the product-substrate combination is discharged from the drop conveyor discharge end towards the receiving conveyor feed end. The folding finger contacts the flap of the product-substrate combination to complete folding of the flap to a second angled position onto the product as the product-substrate combination pivots the flap engaging surface to the second, pass-through position.

A method of rotating a product-substrate combination is also disclosed. The method includes feeding a product-substrate combination onto a rotation conveyor, the rotation conveyor including at least one pair of cleats. The product-substrate combination is aligned via engagement of the product-substrate combination against the at least one pair of cleats. The method includes lifting the product-substrate combination away from the rotation conveyor via a platform and advancing the at least one pair of cleats away from the product-substrate combination. The product-substrate combination is then rotated by 180°. Next, the product-substrate combination is lowered back on to the rotation conveyor. The method includes discharging the product-substrate combination from the rotation conveyor by pushing the at least one pair of cleats against the product-substrate combination.

Further details of the invention are explained in detail below and in the claims.

### BRIEF DESCRIPTION OF THE DRAWINGS

The foregoing summary as well as the following detailed description will be better understood when read in conjunction with the appended drawings. For the purposes of illustrating the invention, there is shown in the drawings an embodiment which is presently preferred. It should be understood, however, that the invention is not limited to the precise arrangement shown. In the drawings:

FIG. 1 is schematic view of a folding arrangement according to a first embodiment.

FIG. 2A is a perspective view of a drop conveyor and a folding assembly of the folding arrangement of FIG. 1 in a first operating condition.

FIG. 2B is a perspective view of the folding assembly of the folding arrangement of FIG. 1 in a second operating condition.

FIG. 3 is a perspective view of a rotation assembly for the folding arrangement.

FIG. 4 is a flow chart of a method according to an embodiment.

FIG. 5 is a schematic view of a rotation assembly.

### DETAILED DESCRIPTION OF THE PREFERRED EMBODIMENTS

Certain terminology is used in the following description for convenience only and is not considered limiting. Words such as “left”, “right”, “front”, “back”, “top”, and “bottom” designate directions in the drawings to which reference is made. This terminology includes the words specifically noted above, derivatives thereof, and words of similar import. Additionally, the terms “a” and “one” are defined as including one or more of the referenced item unless specifically noted. Additionally, a group of items referred to as “at least one of a, b, or c,” refers to any one of a, b, or c, or combinations thereof.

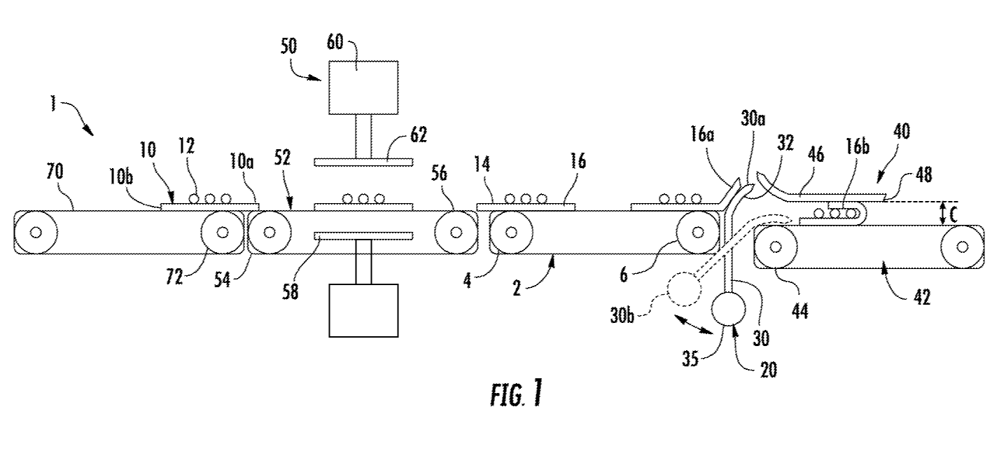

As shown in FIG. 1, a folding arrangement 1 for a product-substrate conveyor assembly is disclosed. The folding arrangement 1 includes a drop conveyor 2 configured to receive a product-substrate combination 10 at a drop conveyor feed end 4 and to direct the product-substrate combination 10 toward a drop conveyor discharge end 6. The product-substrate combination 10 includes a product 12 arranged on a substrate 14 and the substrate 14 includes a flap 16 positioned at a first angled position 16a. In one embodiment, the product 12 is sliced bacon. One of ordinary skill in the art would recognize that the product can include any item, such as food, non-perishable items, dry goods, etc.

A flap lifting assembly 20 is located at the drop conveyor discharge end 6 and includes a pivoting arm 30 with a flap engaging surface 32 that is movable between a first, flap-lifting position 30a and a second, pass-through position 30b. These positions are illustrated in FIG. 1 with the flap-lifting position 30a shown in solid lines, and the second, pass-through position 30b illustrated in broken lines. A double-ended arrow schematically shows the pivoting motion of the arm 30 in FIG. 1.

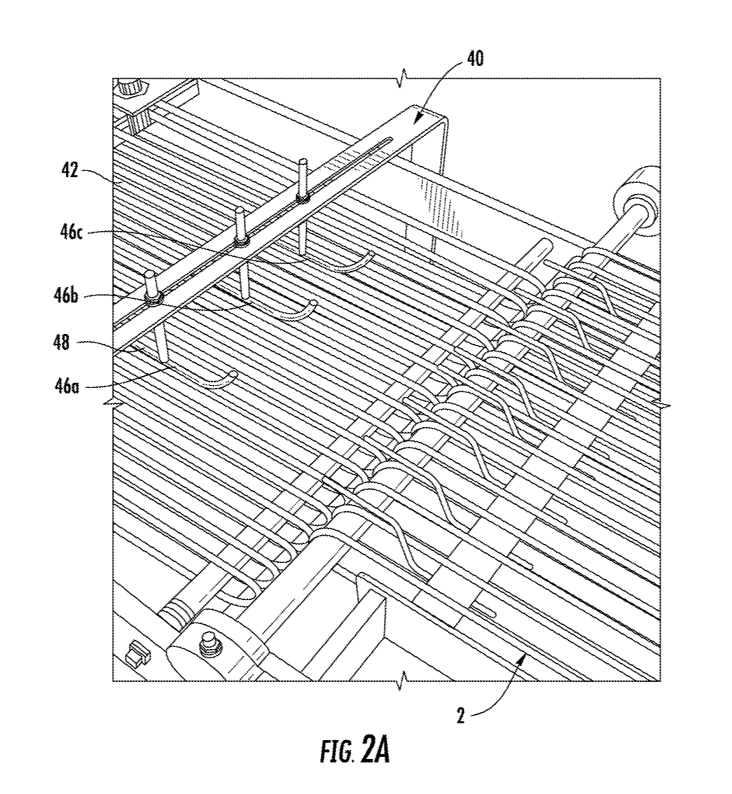

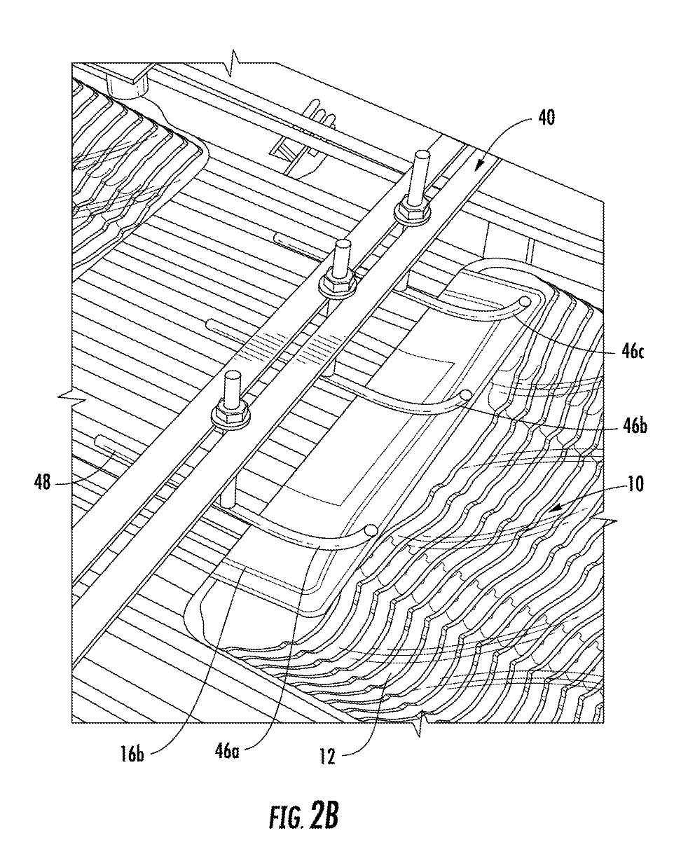

A folding assembly 40 is also shown in FIG. 1 and includes a receiving conveyor 42 with a receiving conveyor feed end 44 positioned below the drop conveyor discharge end 6. The receiving conveyor 42 is configured to receive the product-substrate combination 10 as the product-substrate combination 10 drops downward from the drop conveyor 2. The folding assembly 40 includes a folding finger 46 positioned above the receiving conveyor feed end 44. As shown in FIGS. 2A and 2B, a plurality of folding fingers 46-46c can be provided. The product-substrate combination 10 is driven forward by the drop conveyor 2 into contact with the flap engaging surface 32 of the pivoting arm 30 in the first, flap-lifting position 30a to lift the flap 16 to its first angled position 16a as the product-substrate combination 10 is simultaneously discharged from the drop conveyor discharge end 6 towards the receiving conveyor feed end 44.

The drop conveyor discharge end 6 discharges the product-substrate combination 10 in an area defined between the folding finger 46 and the receiving conveyor 42. The folding finger 46 contacts the flap 16 of the product-substrate combination 10 to complete folding of the flap 16 to a second angled position 16b onto the product 12 as the product-substrate combination 10 moves the flap engaging surface 32 of the pivoting arm 30 to the second, pass-through position 30b. The pivoting arm 30 is biased to return to its first, flap-lifting position 30a as soon as the product-substrate combination 10 is driven by the receiving conveyor 42 out of engagement with the pivoting arm 30 in its second, pass-through position 30b. In one embodiment, the arm 30 includes a counterweight 35 or a spring (not shown) on an opposite end of the arm 30 from the flap engaging surface 32. One of ordinary skill in the art would recognize from the present disclosure that alternative configurations can be provided to return the pivoting arm 30 to the first, flap-lifting position 30a from the second, pass-through position 30b.

As shown in FIGS. 1, 2A, and 2B, the folding assembly 40 preferably includes a rail 48 extending away from the folding finger 46 and above the receiving conveyor 42. The rail 48 is configured to hold the flap 16 in the second angled position 16b as the product-substrate combination 10 is directed onward by the receiving conveyor 42. One of ordinary skill in the art will recognize that the length of the rail 48 can be varied depending on a specific application. One of ordinary skill in the art would also recognize from the present disclosure that a plurality of rails 48 can be provided above the receiving conveyor 42, each attached to one of the plurality of folding fingers 46a-46c. A clearance (C), shown in FIG. 1, is preferably defined between the receiving conveyor feed end 44 and the rail 48 of the folding finger 46. The clearance (C) is preferably 10%-30% larger than an overall height of the product-substrate combination 10 when the flap 16 is folded in the second angled position 16b.

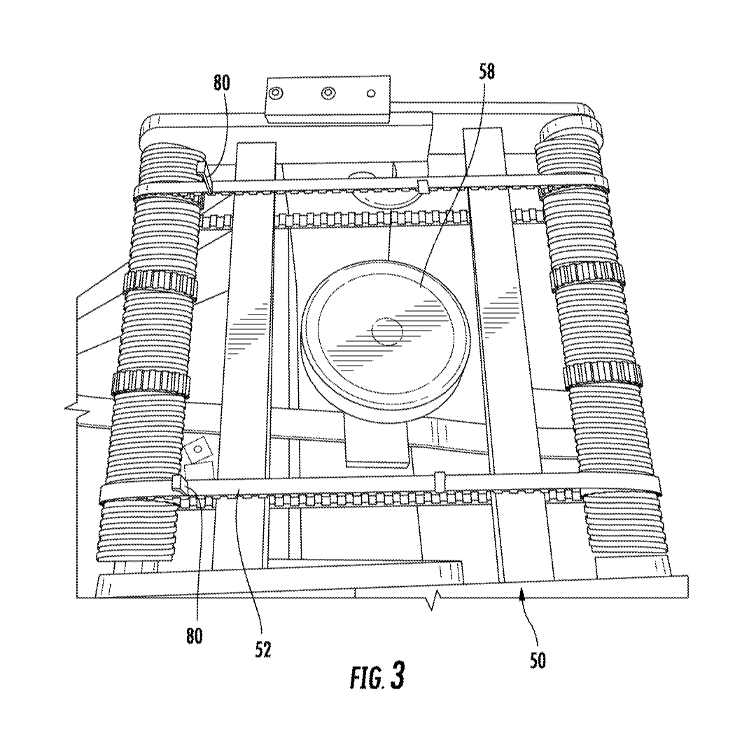

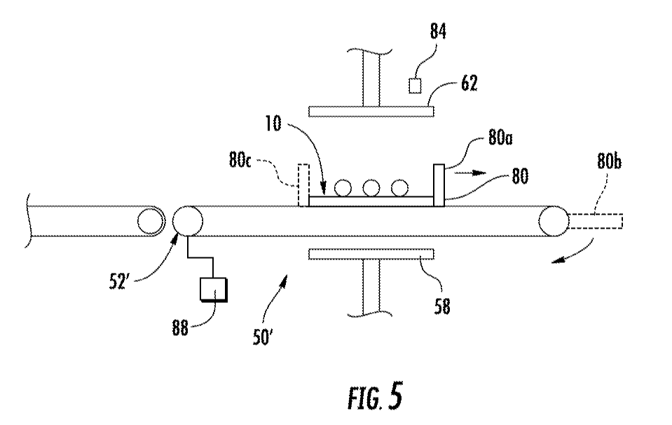

The flap engaging surface 32 is preferably defined by a ramped surface that is configured to guide the flap 16 in an upward direction relative to the drop conveyor 2 and into contact with the folding finger 46 as the product-substrate combination 10 moves from the drop conveyor 2 to the receiving conveyor 42. The ramped surface of flap engaging surface 32 ensures that the flap 16, which is originally in a straight configuration while riding on the conveyors, is angled to the first angled position 16a as the product-substrate combination 10 is discharged from the drop conveyor 2. The folding finger 46 then ensures folding of the flap 16 is completed, and engages the flap 16 to bend the flap into the second angled position 16b, in which the flap 16 rests on top of the product 12.
In one embodiment, the flap 16 of the product-substrate combination 10 is defined at a leading edge 10a of the product-substrate combination 10. In another embodiment, the flap 16 is defined at a trailing edge 10b of the product-substrate combination 10. In situations in which the flap 16 is defined at the trailing edge 10b, it is desirable to rotate the product-substrate combination 10 by 180° prior to arriving at the flap lifting assembly 20 and the folding assembly 40. To perform this rotation, in one embodiment, a rotation assembly 50 is provided that includes a rotation conveyor 52 having a rotation conveyor feed end 54 configured to receive the product-substrate combination 10. The rotation conveyor 52 is configured to direct the product-substrate combination 10 towards a rotation conveyor discharge end 56. As shown in FIG. 3, the rotation assembly 50 preferably includes a platform 58 arranged on a first side of the rotation conveyor 52 and between the rotation conveyor feed end 54 and the rotation conveyor discharge end 56, and a rotary motor 60 arranged on a second opposite side of the rotation conveyor 52 and between the rotation conveyor feed end 54 and the rotation conveyor discharge end 56. The rotary motor 60 includes a platen 62 configured to engage a first surface of the product-substrate combination 10 while the platform 58 engages a second opposite surface of the product-substrate combination 10 to rotate the product-substrate combination 10 relative to the rotation conveyor 52. In a preferred embodiment, the rotatory motor 60 is provided above the rotation conveyor 52, and the platform 58 is provided below the rotation conveyor 52. The rotation assembly 50 preferably rotates the product-substrate combination 10 by 180°. The rotation assembly 50 rotates the product-substrate combination 10 such that the flap 16 is rotated from the trailing edge 10b of the product-substrate combination 10 to the leading edge 10a of the product-substrate combination 10. The platform 58 and the rotary motor 60 can be controlled via an actuator and controller. As shown in FIG. 3, the rotation conveyor 52 preferably includes two bands spaced apart and extending between rollers. A gap defined between the bands provides space for the platform 58 and the rotary motor 60 and platen 62 to engage the product-substrate combination 10. Another embodiment of the rotation assembly 50′ is shown in FIG. 5.

As shown in FIG. 1, a feed conveyor 70 is configured to direct the product-substrate combination 10 toward a feed conveyor discharge end 72 and onto the rotation conveyor feed end 54. One of ordinary skill in the art would recognize from the present disclosure that the product-substrate combination 10 can be directly fed onto the rotation conveyor 52, the drop conveyor 2, or any other type of conveyor prior to encountering the flap lifting assembly 20 and the folding assembly 40. The conveyors are all preferably formed by rollers at ends of the conveyors with a plurality of bands extending between the bands, such that rotation of the rollers drives the bands and directs the product-substrate combination 10 along the conveyors. One of ordinary skill in the art would recognize from the present disclosure that alternative arrangements for the conveyors can be used.

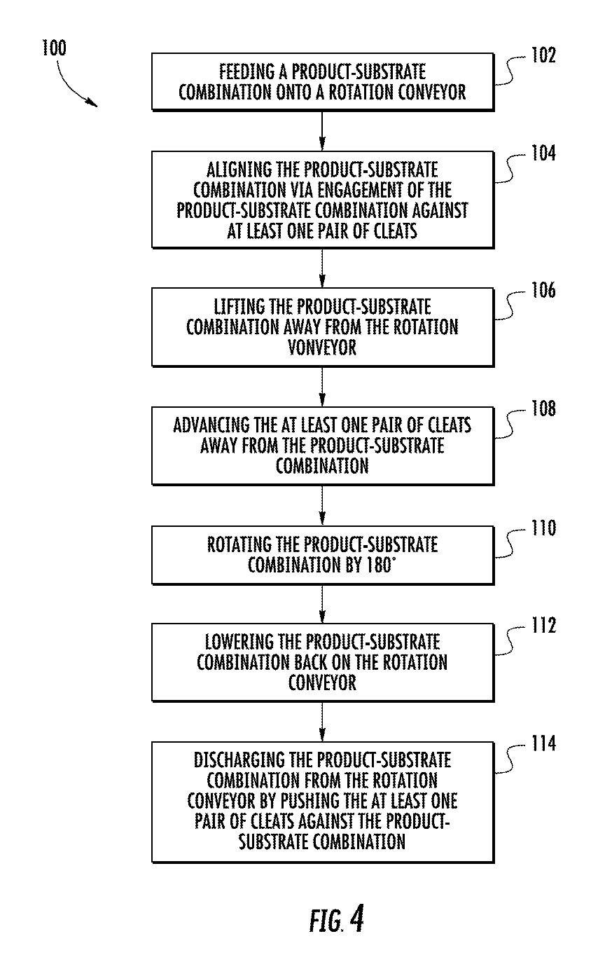

In one embodiment shown in FIG. 4, a method 100 of rotating the product-substrate combination 10 is provided. A rotation assembly 50′ is provided for carrying out the method 100 described in more detail below. The rotation assembly 50′ can include all of the elements described above with respect to the rotation assembly 50. The method includes feeding 102 a product-substrate combination 10 onto a rotation conveyor 52′, and the rotation conveyor 52′ includes at least one pair of cleats 80 (shown in FIG. 3, and shown in multiple positions in FIG. 5 as elements 80a, 80b, and 80c). In one embodiment, the rotation conveyor 52′ is comprised of at least two rollers spaced apart from each other, with at least two bands extending between the at least two rollers. In one embodiment, the at least one pair of cleats 80 includes a plurality of pairs of cleats. The at least one pair of cleats 80 extend generally perpendicular from the rotation conveyor 52′.

The method includes aligning 104 the product-substrate combination 10 via engagement of the product-substrate combination 10 against the at least one pair of cleats 80. The cleats 80 register the produce-substrate combination 10. An advancing edge of the product-substrate combination 10 engages the cleats 80. The cleats 80 are preferably stationary (shown in position 80a) as the product-substrate combination 10 engages the cleats 80. The method includes lifting 106 the product-substrate combination 10 away from the rotation conveyor 52′ via a platform 58. The method includes advancing 108 the at least one pair of cleats 80 away from the product-substrate combination 10 (shown as position 80b). The cleats 80 are advanced to provide enough clearance for the platform 58 and the platen 62 to rotate 110 the product-substrate combination 10 by 180°. One of ordinary skill in the art would recognize from the present disclosure that the platform 58 can be provided on the top or bottom of the rotation conveyor 52′, and the platen 62 on the rotary motor 60 can be provided on the top or bottom of the rotation conveyor 52′.

The method includes lowering 112 the product-substrate combination 10 back on to the rotation conveyor 52′ and discharging 114 the product-substrate combination 10 from the rotation conveyor 52′ by pushing the at least one pair of cleats 80 against the product-substrate combination 10. The cleats 80 engage a trailing edge of the product-substrate combination 10 (shown as position 80c) to push the product-substrate combination 10 forward and off of the rotation conveyor 52′. A motor 88 is provided to drive the rotation conveyor 52′. The motor 88 is preferably a servo-motor. The motor 88 drives the rotation conveyor 52′ at a high speed and stop the rotation conveyor 52′ such that the rotation conveyor 52′ can rotate at least sixty product-substrate combinations 10 per minute. In one embodiment, a sensor 84 is provided to detect a presence of the product-substrate combination 10 as it engages the cleats 80. The sensor 84 is preferably a photo-sensor. A time delay can be provided between the moment the sensor 84 detects the presence of the product-substrate combination 10 and the steps of lifting the product-substrate combination 10 away from the rotation conveyor 52′ and advancing the cleats 80. Alternatively, the lifting and advancing steps can be carried out immediately as the presence of the product-substrate combination 10 is detected. In an embodiment with a single pair of cleats 80, the cleats 80 must complete a full cycle around the rotation conveyor 52′ to move a single product-substrate combination 10 through the rotation assembly. In an embodiment with additional pairs of cleats 80, multiple product-substrate combinations 10 can be processed by a single cycle of the rotation conveyor 52′.

While the invention has been described in detail based on the presently preferred embodiment, it would be recognized by those skilled in the art that the invention is not limited to the preferred embodiments, but rather is defined by the appended claims.

What is claimed is:

1. A folding arrangement for a product-substrate combination comprising:
a drop conveyor configured to receive a product-substrate combination at a drop conveyor feed end and to direct the product-substrate combination toward a drop conveyor discharge end, the product-substrate combination including a product arranged on a substrate and the substrate includes a flap positioned at a first angled position;
a flap lifting assembly located at the drop conveyor discharge end and including a pivoting arm with a flap engaging surface that is movable between a first, flap-lifting position and a second, pass-through position; and
a folding assembly including a receiving conveyor including a receiving conveyor feed end positioned below the drop conveyor discharge end, and a folding finger positioned above the receiving conveyor feed end;
the product-substrate combination is driven by the drop conveyor into contact with the flap engaging surface in the first, flap-lifting position to lift the flap as the product-substrate combination is discharged from the drop conveyor discharge end towards the receiving conveyor feed end, and the folding finger contacts the flap of the product-substrate combination to complete folding of the flap to a second angled position onto the product as the product-substrate combination pivots the flap engaging surface to the second, pass-through position.

2. The folding arrangement of claim 1, wherein the flap of the product-substrate combination is defined at a leading edge of the product-substrate combination.

3. The folding arrangement of claim 1, wherein the arm includes a counterweight or a spring on an opposite end of the arm from the flap engaging surface.

4. The folding arrangement of claim 1, wherein the folding assembly includes a rail extending away from the folding finger and above the receiving conveyor, and the rail is configured to hold the flap in the second angled position as the product-substrate combination is directed by the receiving conveyor.

5. The folding arrangement of claim 1, wherein the flap engaging surface is defined by a ramped surface configured to guide the flap in an upward direction relative to the drop conveyor and into contact with the folding finger as the product-substrate combination moves from the drop conveyor to the receiving conveyor.

6. The folding arrangement of claim 1, further comprising a rotation assembly including a rotation conveyor having a rotation conveyor feed end configured to receive the product-substrate combination, and the rotation conveyor is configured to direct the product-substrate combination towards a rotation conveyor discharge end.

7. The folding arrangement of claim 6, wherein the rotation assembly includes a platform arranged on a first side of the rotation conveyor and between the rotation conveyor feed end and the rotation conveyor discharge end, and a rotary motor arranged on a second opposite side of the rotation conveyor and between the rotation conveyor feed end and the rotation conveyor discharge end, the rotary motor includes a platen configured to engage a first surface of the product-substrate combination while the platform engages a second opposite surface of the product-substrate combination to rotate the product-substrate combination relative to the rotation conveyor.

8. The folding arrangement of claim 7, wherein the rotation assembly rotates the product-substrate combination such that the flap is rotated from a trailing edge of the product-substrate combination to a leading edge of the product-substrate combination.

9. The folding arrangement of claim 7, further comprising a feed conveyor configured to direct the product-substrate combination toward the feed conveyor discharge end and onto the rotation conveyor feed end.

10. The folding arrangement of claim 1, wherein a clearance defined between the receiving conveyor and the folding finger is 10%-30% larger than an overall height of the product-substrate combination when the flap is folded in the second angled position.

11. The folding arrangement of claim 1, wherein the drop conveyor discharge end discharges the product-substrate combination in an area defined between the folding finger and the receiving conveyor.

12. A method of rotating a product-substrate combination, the method comprising:
(a) feeding a product-substrate combination onto a rotation conveyor, the rotation conveyor including at least one pair of cleats;
(b) aligning the product-substrate combination via engagement of the product-substrate combination against the at least one pair of cleats;
(c) lifting the product-substrate combination away from the rotation conveyor via a platform;
(d) advancing the at least one pair of cleats away from the product-substrate combination;
(e) rotating the product-substrate combination by 180°;
(f) lowering the product-substrate combination back on to the rotation conveyor; and
(g) discharging the product-substrate combination from the rotation conveyor by pushing the at least one pair of cleats against the product-substrate combination.

13. The method of claim 12, wherein a sensor is used to detect a presence of the product-substrate combination in step (b).

14. The method of claim 12, wherein the at least one pair of cleats are stationary in step (a).

15. The method of claim 12, wherein the rotation conveyor is comprised of at least two rollers spaced apart from each other, with at least two bands extending between the at least two rollers.

16. The method of claim 12, wherein the at least one pair of cleats includes a plurality of pairs of cleats.

17. The method of claim 12, wherein the at least one pair of cleats extend generally perpendicular from the rotation conveyor.
